(19) United States
(12) Patent Application Publication
(10) Pub. No.: US 2024/0291347 A1
(43) Pub. Date: Aug. 29, 2024

(54) ELECTRIC MOTOR OF AN AUXILIARY ASSEMBLY OF A MOTOR VEHICLE

(71) Applicant: Brose Fahrzeugteile SE & Co. Kommanditgesellschaft, Würzburg, Würzburg (DE)

(72) Inventors: Ralf Lieschke, Hagen (DE); Moritz Obendorfer, Würzburg (DE)

(21) Appl. No.: 18/628,992

(22) Filed: Apr. 8, 2024

Related U.S. Application Data
(63) Continuation of application No. PCT/EP2022/077519, filed on Oct. 4, 2022.

(30) Foreign Application Priority Data
Oct. 8, 2021 (DE) 10 2021 211 366.4

(51) Int. Cl. H02K 7/00; H02K 7/116

(52) U.S. Cl. CPC H02K 7/003; H02K 7/116

(57) ABSTRACT

An electric motor of an ancillary unit or an auxiliary assembly of a motor vehicle, in particular an electromechanical brake booster, includes a rotor shaft which is disposed along a rotor axis. The rotor shaft includes a cylindrical main portion, which has a round cross-section perpendicular to the rotor axis, and an assembly portion, which adjoins the main portion and has a barrel-shaped cross-section perpendicular to the rotor axis. The barrel-shaped cross-section has two parallel main edges and two convex edges. A gear wheel is positioned on the assembly portion. The gear wheel has a central assembly opening with a barrel-shaped cross-section perpendicularly to the rotor axis. An ancillary unit or auxiliary assembly of a motor vehicle is also provided.

The invention relates to an electric motor of an ancillary unit of a motor vehicle. The invention furthermore relates to an ancillary unit of a motor vehicle.

Motor vehicles such as passenger motor vehicles have a multiplicity of ancillary units which do not directly serve for propelling the motor vehicle. Ancillary units of this type are required for operating the main drive, for example, or serve to provide or enhance the comfort level for the user of the motor vehicle. An ancillary unit of this type is, for example, an electromotive adjustment drive such as an electromotive window regulator. Alternatively, the ancillary unit is an electromotive refrigerant compressor, for example, which is in particular a constituent part of a refrigerant circuit of the motor vehicle.

In another alternative, the electric motor is a constituent part of the brake system of the motor vehicle. The electric motor herein is, for example, a constituent part of an anti-lock brake system, of a traction control system, or of a brake force distributor activated by an electric motor. However, it is also possible for the electric motor to be used in a brake booster. In the latter, an applied pedal force is in particular boosted by means of the electric motor. For example, the brake booster is at least in part of a hydraulic design, and in particular a hydraulic pump is operated and/or potential valves are activated by means of the electric motor.

Alternatively, the brake booster is of an electromechanical design. The electromechanical brake booster herein in most instances comprises an input rod which for activating the brake is moved in a longitudinal direction by means of a foot pedal. The input rod acts on a working piston by means of which a pressure in a brake fluid system is increased. The electric motor acts on the input rod in such a way that an activation of the foot pedal is facilitated. Thus, a force to be applied by a user for activating the brake is reduced. Moreover, by virtue of the electric motor, the brake booster is independent of any actual activation of the foot pedal, and the input rod, particularly by means of the electric motor, can be moved independently of the foot pedal as a function of specified driving situations, this leading to the motor vehicle being decelerated.

A gearbox which is driven by means of the electric motor is in most instances provided in order for the electric motor to act on the input rod. A gear wheel is usually fastened to a rotor shaft of the electric motor for this purpose. This gear wheel is in most instances pressed onto the hollow-cylindrically designed rotor shaft by means of a press-fit. A comparatively strong force-fit between the gear wheel and the rotor shaft is required so that the forces arising in driving the gearbox do not lead to the gear wheel being released from the rotor shaft. In order to avoid damage to the gear wheel in the process, it is necessary for the latter to be of a comparatively robust design, which leads to a comparatively high weight. The consequences are increased inertia and reduced dynamics of the electric motor.

The invention is based on the object of specifying a particularly suitable electric motor of an ancillary unit of a motor vehicle, and a particularly suitable ancillary unit of a motor vehicle, wherein robustness is advantageously increased and/or production costs are reduced, and wherein production is suitably simplified.

In terms of the electric motor, this object is achieved according to the invention by the features of claim 1, and in terms of the ancillary unit by the features of claim 10. Advantageous refinements and design embodiments are the subject matter of the respective dependent claims.

The electric motor is a constituent part of an ancillary unit. The electric motor is suitable, in particular provided and specified, for this purpose. The ancillary unit is a constituent part of a motor vehicle. In other words, the ancillary unit in the intended state is assembled on further constituent parts of the motor vehicle. The ancillary unit is suitable, in particular provided and specified, for this purpose. The motor vehicle is in particular land-based and preferably designed with a plurality of tracks. It is suitably possible for the motor vehicle herein to be substantially freely placed, for example on a corresponding road surface. For this purpose, the motor vehicle has in particular suitable wheels. In summary, it is preferably possible for the motor vehicle to be positioned on terrain substantially irrespective of other conditions. In other words, the motor vehicle is suitably not rail-bound. The motor vehicle is preferably a passenger motor vehicle or a commercial motor vehicle such as a motor truck or bus.

In the intended use, the ancillary unit does not directly serve for propelling the motor vehicle and thus does not represent a main drive of the motor vehicle. For example, the ancillary unit herein serves for operating the main drive, or for providing functions required for the operation of the motor vehicle, said functions not serving directly for propelling the motor vehicle. Alternatively, a comfort level is enhanced, or comfort functions are provided, by means of the ancillary unit.

The ancillary unit has for example a nominal or maximal output between 100 W and 1000 W, preferably between 300 W and 700 W, and, for example, between 400 W and 500 W. The ancillary unit is, for example, an electromotive adjustment drive such as an electromotive window regulator. Alternatively, the ancillary unit is, for example, an electromotive refrigerant compressor, which is in particular a constituent part of a refrigerant circuit of the motor vehicle. In another alternative, the ancillary unit is an electromotive pump such as a water pump. The electromotive pump is suitably a lubricant pump such as a motor oil pump or a transmission oil pump. A pump wheel which is adapted to the liquid to be pumped is in each case driven by means of the electric motor herein. In another alternative, the electric motor is a constituent part of a fan such as of a radiator fan or of a blower, which thus represent the respective ancillary unit. In one alternative, the ancillary unit is a steering servo, and a steering rod is in particular driven by means of the electric motor, or at least one steering movement of wheels of a steerable design of the motor vehicle is adjusted by means of the electric motor, or the adjustment of said wheels is facilitated by the latter.

In another alternative, the ancillary unit is a brake system or part of the brake system of the motor vehicle. The electric motor herein is, for example, a constituent part of an anti-lock brake system, of a traction control system, or of a brake force distributor activated by an electric motor. The ancillary unit is particularly preferably a brake booster, wherein a pedal force applied to a brake pedal by a user, also referred to as operator or driver, is in particular boosted by means of the electric motor during operation. For example, the brake booster is at least in part of a hydraulic design, and in particular a hydraulic pump is operated and/or potential valves are activated by means of the electric motor.

For example, the brake booster is at least in part of a hydraulic design, and in particular a hydraulic pump is operated and/or potential valves are activated by means of the electric motor. Particularly preferably however, the brake booster is of an electromechanical design, and the ancillary unit is thus an electromechanical brake booster. A construction of the ancillary unit is consequently simplified.

The electromechanical brake booster expediently comprises an input rod which for activating the brake is moved in a longitudinal direction by means of a foot pedal. The foot pedal herein is, for example, articulated directly on the input rod, or for example via a rod assembly. However, the foot pedal is at least operatively connected to the input rod. The input rod acts on a working piston. For example, the working piston is fastened directly to the input rod, in particular integrally molded thereon. Alternatively, a further mechanism is disposed therebetween. The working piston is in particular disposed in a pump chamber in which a brake fluid is present during operation. Depending on the direction of movement, the brake fluid is forced out of the pump chamber or suctioned into the latter during a linear movement of the working piston in the pump chamber. Potential brake pistons of brakes of a brake system of the motor vehicle are preferably hydraulically connected to the pump chamber in such a way that the brakes are activated when the brake fluid is forced out of the pump chamber.

The input rod is expediently provided with a thread on the circumference, a drive pinion with internal toothing being placed on said thread. Here, a type of spindle is formed by means of the input rod and the drive pinion. The drive 9 pinion is expediently driven by means of the electric motor, for example directly or preferably by way of a gearbox. When the electric motor is energized, a force is thus introduced into the input rod by the drive pinion, and consequently also onto the working piston.

The electromechanical brake booster preferably comprises a sensor by means of which an activation of the foot pedal acting as the brake pedal is detected during operation. The electric motor is energized as a function thereof. The electromechanical brake booster suitably comprises a control apparatus by means of which the sensor is read and the energization of the electric motor is adjusted. In a refinement, the electric motor is energized by means of the control apparatus irrespective of an actual activation of the foot pedal, preferably as a function of a provided command which is in particular transmitted by way of a potential bus system. The command herein is initiated, for example, by an assistance system of the motor vehicle or of an on-board computer of the motor vehicle. The command herein is in particular initiated as a function of specific driving situations, for example by an emergency brake assistant. Alternatively or in combination therewith, the motor vehicle is designed to be partially or completely autonomous in such a way that travel takes place independently of control by a user. The command herein is in particular initiated by a so-called autopilot.

The electric motor has a rotor shaft which is disposed along a rotor axis which is also referred to as motor axis or rotation axis. The rotor shaft is expediently integral and made of steel, for example. A rotor of the electric motor is preferably fastened to the rotor shaft, said rotor having at least one magnet, for example. During operation, the magnet expediently interacts with a magnet of a stator which preferably circumferentially surrounds the rotor and is in particular of a hollow-cylindrical design and disposed concentrically with the rotor axis.

For example, the electric motor is a brush commutator motor, and the stator comprises a permanent magnet. However, the electric motor is particularly preferably a brushless electric motor, for example a brushless DC (BLDC) motor. In this case, the rotor preferably has one or a plurality of permanent magnets which is/are fastened to the rotor shaft. For example, the permanent magnets are fastened to a laminated core, or embedded in the latter, which is fastened to the rotor shaft. The stator surrounding the rotor preferably comprises one or a plurality of solenoids which are expediently divided among a plurality of phases. Each of the phases is in particular assigned the same number of solenoids, each of the latter having in particular one electric coil. The electric motor suitably comprises three phases which are connected to one another in a delta connection or star connection, for example.

The electric motor particularly preferably comprises one or two bearing shields by way of each of which one bearing is held. The bearing is in each case expediently designed as a rolling bearing, for example as a ball bearing. The rotor shaft is mounted so as to be rotatable about the rotor axis by means of the bearing, or bearings, respectively, in such a way that the rotor shaft rotates about the rotor axis when the electric motor, in particular the solenoids thereof, are energized.

The rotor shaft comprises a cylindrical main portion which is disposed concentrically with the rotor axis and has a round cross section perpendicular to the rotor axis. The cross section herein is expediently circular and constant across the entire extent of the main portion along the rotor axis. Manufacturing is simplified in this way. The potential rotor is suitably fastened to the main portion of the rotor shaft, and the potential bearings, or at least the potential bearing, are/is also fastened to the main portion. Manufacturing is simplified in this way.

Furthermore, the rotor shaft has an assembly portion which adjoins the main portion and is thus offset along the rotor axis from the main portion. The assembly portion likewise extends along the rotor axis and is expediently directly contiguous to the main portion. The rotor shaft comprises in particular only the main portion and the assembly portion which are fastened to one another, in particular integrally fastened to one another. Manufacturing is simplified in this way.

The assembly portion has at least in portions a barrel-shaped cross section perpendicular to the rotor axis, which thus has two mutually parallel main edges and two convex edges. The convex edges are arcuate, whereby the center of the arc lies in particular on the rotor axis. Consequently, the cross section is designed in the manner of a dihedron.

A gear wheel which thus circumferentially surrounds the assembly portion is placed onto the assembly portion. The gear wheel has a number of teeth and is disposed concentrically with the rotor axis in such a way that the teeth form the circumference of the gear wheel. In this way, the gear wheel is designed with external toothing. A trough is in each case formed in the tangential direction relative to the rotor axis between respectively neighboring teeth. The assembly portion forms in particular one end of the rotor shaft in such a way that the gear wheel forms in particular a spur gear of the electric motor. In the 14 assembled state, the gear wheel expediently engages with further constituent parts of the ancillary unit, said constituent parts thus being driven by way of the gear wheel.

The gear wheel has a central assembly opening along which the rotor axis runs. The assembly opening is in particular disposed concentrically with the rotor axis and has a barrel-shaped cross section perpendicular to the rotor axis. The barrel-shaped cross section of the assembly opening preferably corresponds to the barrel-shaped cross section of the assembly portion, and these are expediently identical to one another. However, the central assembly opening also has at least two mutually parallel main edges and two convex, thus arcuate, edges, whereby the center of the arc lies in particular on the rotor axis. The assembly opening suitably rests circumferentially on the assembly portion in such a way that centering of the gear wheel is performed by said assembly portion. Consequently, said gear wheel is likewise disposed concentrically with the rotor axis. A form-fit is particularly preferably established between the assembly opening and the assembly portion.

By virtue of the mutually corresponding barrel-shaped cross sections of the assembly opening and of the assembly portion, a transmission of force to the gear wheel during operation of the electric motor is performed by means of a form-fit, specifically by virtue of the mutually parallel main edges. Consequently, the further constituent parts of the gear wheel are subjected to comparatively little stress during the transmission of force, so that robustness is increased. It is also not necessary for the gear wheel to be of a comparatively massive design, so that a torque of inertia of the electric motor is reduced and dynamics are increased.

The mechanical connection by means of which the transmission of force between the gear wheel and the rotor shaft is made possible requires only that the gear wheel is placed onto the assembly portion, which is why production is simplified. Because providing the barrel-shaped cross section of the assembly portion moreover only requires flattening, thus a subtraction of material, production is simplified and accelerated so that production costs are reduced. Moreover, it is possible for the rotor shaft and the gear wheel to be produced from dissimilar materials, which is why flexibility is increased.

It is possible herein to optimize the materials so as to match the respective intended application, so as to further increase robustness. The rotor shaft is in particular made of steel, preferably high-grade steel, or any other high-strength steel. Robustness is increased in this way. It is consequently possible to choose the diameter of the cross section of the rotor shaft to be comparatively small in the region of the main portion in such a way that the rotor shaft inertia, and thus the inertia of the electric motor, is further reduced.

The gear wheel is in particular made by sintering, and made of metal or ceramics, for example. There is a comparatively free choice of the shape for the gear wheel by virtue of the sintering, so that said gear wheel can be adapted to the field of application. It is also possible for the gear wheel to be made of a material with comparatively little friction or a self-lubricating material, so that an efficiency of the electric motor is improved. Also, comparatively extensive post-machining is not required by virtue of the sintering, so that production time is further reduced.

For example, the gear wheel has a cycloidal toothing. Particularly preferably however, the gear wheel has an involute toothing. Production is consequently simplified. Moreover, a constant transmission of torque is enabled, which is why an operation is homogenized. If the ancillary unit is designed as a brake booster, a braking force or braking pressure is thus substantially continuously increased, and there is thus continuous deceleration of the motor vehicle. Moreover, a transmission of force is also enabled when the electromechanical brake booster is subjected to shock and the position of the rotor axis relative to the rotation axis of the component to be driven is momentarily changed as a result, which is why robustness of the ancillary unit is increased.

For example, the assembly portion also has a cylindrical region which thus comprises a round cross section. The assembly opening herein expediently likewise comprises a region with a round cross section. A simplified production of the gear wheel, for example by means of sintering, is consequently made possible. For example, simplified centering of the gear wheel also takes place by means of the round cross section. Particularly preferably however, the assembly portion has the barrel-shaped cross section across the entire extent of the former along the rotor axis, just like the assembly portion. In this way, the mechanical contact between the gear wheel and the rotor shaft, which is utilized for the transmission of force, is enlarged in such a way that robustness is increased. Moreover, the requirements set in terms of the stiffness of the material of the gear wheel and of the rotor shaft are reduced, which is why comparatively cost-effective materials can be used.

For example, the gear wheel has a straight toothing, and the teeth are disposed parallel to the rotor axis. Consequently, forces act only in the tangential direction between the gear wheel and the rotor shaft during operation, thus acting on the mutually parallel main edges of the two barrel-shaped cross sections. In contrast, no appreciable forces arise in any other direction. Comparatively extensive fixing of the gear wheel to the rotor shaft is not required by virtue of the comparatively minor forces acting on the gear wheel parallel to the rotor axis, thus in the axial direction. For example, for this purpose the gear wheel is fastened to the rotor shaft in a materially integral manner, for example by means of adhesive bonding or welding.

Particularly preferably however, the gear wheel has a helical toothing relative to the rotor axis, and the teeth thus run obliquely relative to the rotor axis. In other words, each tooth is disposed so as to correspond to a helical shape. In other words, each tooth describes at least partially the shape of a helix. Consequently, smooth running of the electric motor and of the potential component driven by the latter is enhanced, and noise generation is reduced. However, in this way additional forces act on the gear wheel in the axial direction during operation, thus parallel to the rotor axis. The gear wheel is suitably fastened to the rotor shaft in such a manner that these forces are also absorbed in such a way that a release of the gear wheel from the rotor shaft is avoided.

For example, the main edges of the assembly portion and of the assembly opening rest loosely on one another. Particularly preferably however, an interference fit is established between the main edges of the assembly portion and of the assembly opening, and the faces defined thereby. Consequently, the gear wheel rests on the rotor shaft in a force-fitting manner in this region, which is why a transmission of force from the rotor shaft to the gear wheel is improved. Moreover, the gear wheel is not offset due to potential play when the rotating direction of the rotor shaft is reversed, so that stress is reduced. In particular, the gear wheel is stabilized in the axial direction by virtue of the interference fit, thus parallel to the rotor axis, in such a way that axial forces acting between the gear wheel and the rotor axis during operation are compensated and do not lead to the gear wheel being offset relative to the rotor shaft.

The barrel-shaped cross section of the assembly portion herein is in particular oversized relative to the assembly opening of the gear wheel in such a way that for assembling the gear wheel is press-fitted onto the assembly portion. Consequently, the gear wheel is in particular elastically and/or plastically deformed in the region of the convex edges in such a way that the force-fitting resting of the main edges on one another is implemented. In the process, the gear wheel is under tensile stress in the region of the convex edges, which is why damage to the gear wheel in the process is substantially avoided.

Alternatively or in combination therewith, an interference fit is established between the convex edges of the assembly portion and of the assembly opening. Particularly preferably however, a clearance fit is established between the convex edges of the assembly portion and the convex edges of the assembly opening. In this way, the gear wheel is aligned relative to the rotor shaft by virtue of the convex edges, which simplifies assembling. However, comparatively little mechanical stress arises in the region of the gear wheel in which there is only a comparatively minor material thickness, thus where the thickness of the wall between the assembly opening and the troughs formed between the teeth is reduced in comparison to the thickness of the wall in the region of the main edges. Consequently, damage to the gear wheel during assembling or else during operation is avoided. Moreover, it is possible to choose a comparatively thin wall thickness of the gear wheel in this region in such a way that a weight of the gear wheel, and thus inertia of the electric motor, is reduced.

For example, in the barrel-shaped cross section of the assembly portion and/or of the assembly opening, the main edges transition into the respectively neighboring convex edges by means of a curvature or an arc. Particularly preferably however, a corner is in each case formed between each main edge and the respectively neighboring convex edges of the cross sections, or of at least one of the cross sections. A transmission of force between the gear wheel and the rotor shaft is further improved in this way. However, there is a comparatively high load on the gear wheel in the region of the corner. Therefore, one tooth of the gear wheel is preferably disposed in each case so as to neighbor each of the corners of the cross section in the radial direction in such a way that the wall of the gear wheel is thickened in this region. In other words, a wall thickness of the gear wheel is increased by virtue of one tooth being in each case disposed so as to be radially offset from the respective corner. Overloading of the gear wheel in the region of the corner is thus avoided, and robustness is consequently increased. In summary, one tooth is offset from each corner so as to be disposed radially outside in the radial direction which is determined relative to the rotor axis, and the troughs disposed between the teeth are expediently offset from each of the corners in the radial direction and additionally in the tangential direction.

The gear wheel herein has in particular a straight toothing. If the gear wheel has a helical toothing, part of the tooth is in each case suitably disposed in the radial direction relative to each corner over the entire profile in the rotor axis, and in particular none of the troughs is only radially offset relative to each corner. If the pitch of the teeth, thus the angle of the latter relative to the rotor axis, is chosen to be comparatively large, the teeth are preferably disposed in such a manner that one of the troughs is disposed in the radial direction relative to the corner only in a comparatively minor region of the gear wheel, preferably in the smallest possible region, so that stress is at least reduced. The teeth are at least disposed in such a manner that one of the teeth adjoins the corners in each case in the radial direction relative to a comparatively large region along the rotor axis in such a way that the gear wheel has a minimal wall thickness only in a comparatively minor region, said wall thickness being determined in particular between the respective corner and one of the troughs between the teeth. The teeth are in particular disposed symmetrically relative to the respective corner, in particular symmetrical in terms of a point relative to the center of the respective tooth along the rotor axis. Overloading is likewise avoided in this way.

For example, the rotor shaft is designed in multiple pieces. Particularly preferably however, said rotor shaft is integral so that production is simplified. In particular, the area of the cross section of the assembly portion is smaller than the area of the cross section of the main portion. Consequently, it is possible to first design the rotor shaft to be cylindrical, and to machine the assembly portion therefrom by means of subtracting material. In contrast, the portion is formed by the non-machined cylindrical region. Consequently, only a comparatively minor subtraction of material is required, which is why the production of the rotor shaft is simplified. In this way, there is also no comparatively cost-intensive tool required, which simplifies production.

For example, the convex edges of the assembly portion are co-aligned with the edge of the round cross section of the main portion. Consequently, it is avoided that turbulences are formed or foreign particles are deposited there. Particularly preferably however, a circumferentially encircling step is formed between the assembly portion and the main portion, and the convex edges are thus offset in the direction of the rotor axis relative to the 6 delimitation of the round cross section. Consequently, a contact for the gear wheel in the axial direction, which is parallel to the rotor axis, is formed by means of the step, so that assembling of the gear wheel is simplified. In the assembled state, the gear wheel rests in particular on the step. Consequently, the gear wheel is at least partially stabilized by means of the step and the main portion, so that damage to the gear wheel is avoided. Moreover, weight and consequently inertia are further reduced by virtue of the reduced mass in the region of the assembly portion.

The spacing of the troughs of the gear wheel that are formed between neighboring teeth from the rotor axis is particularly preferably smaller than or equal to the radius of the round cross section. Consequently, the gear wheel has a comparatively small diameter, which is why inertia is further reduced.

For example, that end of the assembly portion that faces away from the main portion is blunt, which simplifies manufacturing of the rotor shaft. Particularly preferably however, that end of the assembly portion that faces away from the main portion is beveled in such a way that the cross section thereon is further reduced in size. The bevel produced in this way serves for placing the gear wheel onto the rotor shaft, which simplifies the production of the electric motor. In particular if an interference fit is at least partially established between the assembly opening and the assembly portion, the gear wheel is successively elastically and/or plastically deformed by means of the bevel, this taking place in a substantially continuous manner in such a way that overloading of the gear wheel, for example a breakage of the latter, is avoided.

The ancillary unit is a constituent part of a motor vehicle, the latter being, for example, a commercial motor vehicle such as a bus or a motor truck. Particularly preferably, the ancillary unit in the assembled state is a constituent part of a passenger motor vehicle. The ancillary unit herein does not directly serve for propelling the motor vehicle, but for operating a main drive, for example, for providing comfort functions and/or adjusting a direction of movement of the motor vehicle. The ancillary unit is particularly preferably a brake booster which is particularly preferably of an electromechanical design. During operation of the electric motor, a pressure in a brake fluid system is in particular increased by means of the brake booster herein. The brake fluid system herein particularly comprises a pump chamber of the electromechanical brake booster, suitably a compensation chamber and preferably a plurality of brake pistons, wherein at least one brake piston is in particular assigned to each wheel of the motor vehicle. Each wheel is suitably assigned a plurality of brake pistons which are in particular disposed on a brake caliper.

The ancillary unit has at least one electric motor and a component driven by the latter, wherein the driven component comprises in particular a drive pinion or any other further gear wheel which suitably engages with a gear wheel of the electric motor. The electric motor comprises a rotor shaft which is disposed along a rotor axis. The rotor shaft comprises a cylindrical main portion which has a round cross section perpendicular to the rotor axis, and an assembly portion which adjoins said main portion which has a barrel-shaped cross section perpendicular to the rotor axis, having two mutually parallel main edges and two convex edges. A gear wheel, which has a central assembly opening with a barrel-shaped cross section perpendicular to the rotor axis, is placed onto the assembly portion.

The invention furthermore relates to a motor vehicle having an ancillary unit of this type.

The refinements and advantages explained in the context of the electric motor apply in an analogous manner also to the ancillary unit/the motor vehicle and to one another, and vice versa.

An exemplary embodiment of the invention will be explained in more detail hereunder by means of the drawing in which:

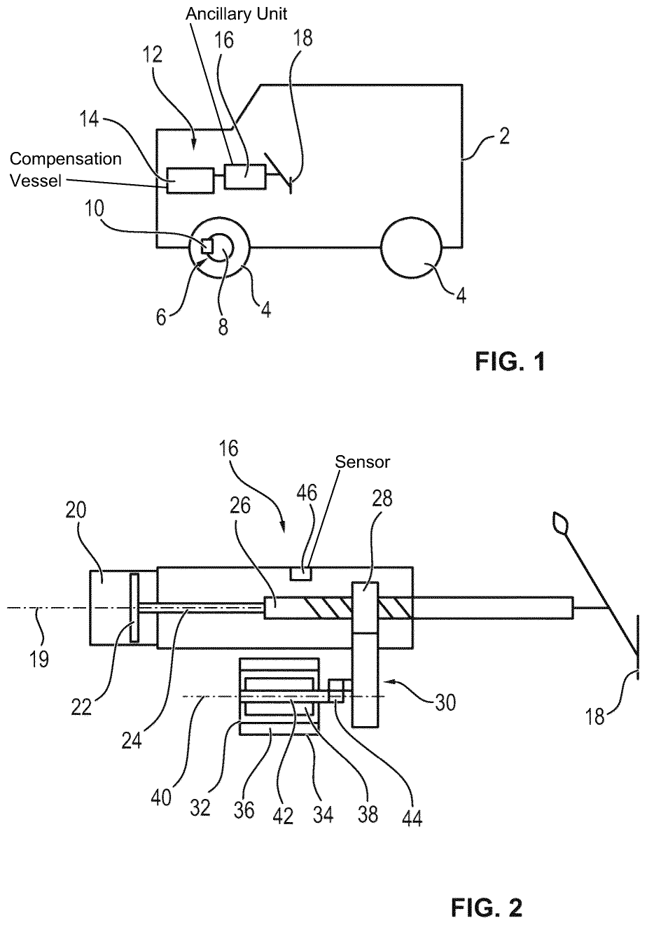

FIG. 1 schematically shows a motor vehicle having an electromechanical brake booster;

FIG. 2 schematically shows the electromechanical brake booster, which has an electric motor, in a sectional illustration;

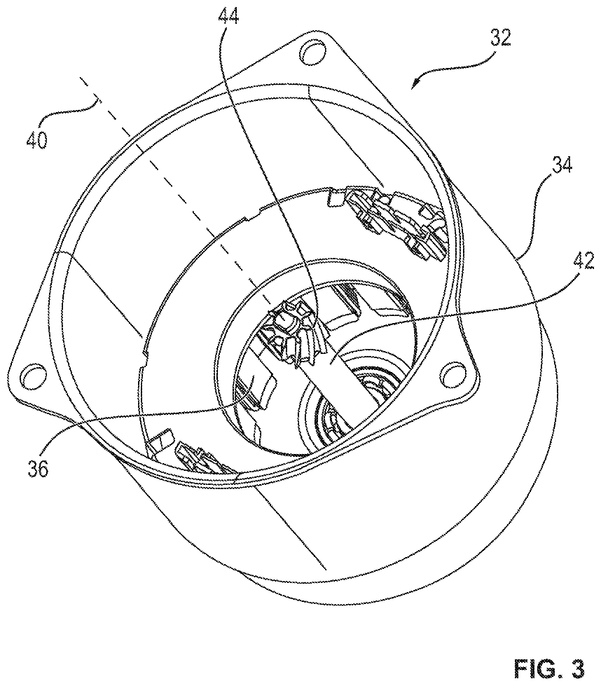

FIG. 3 shows a perspective fragmented view of the electric motor having a rotor shaft;

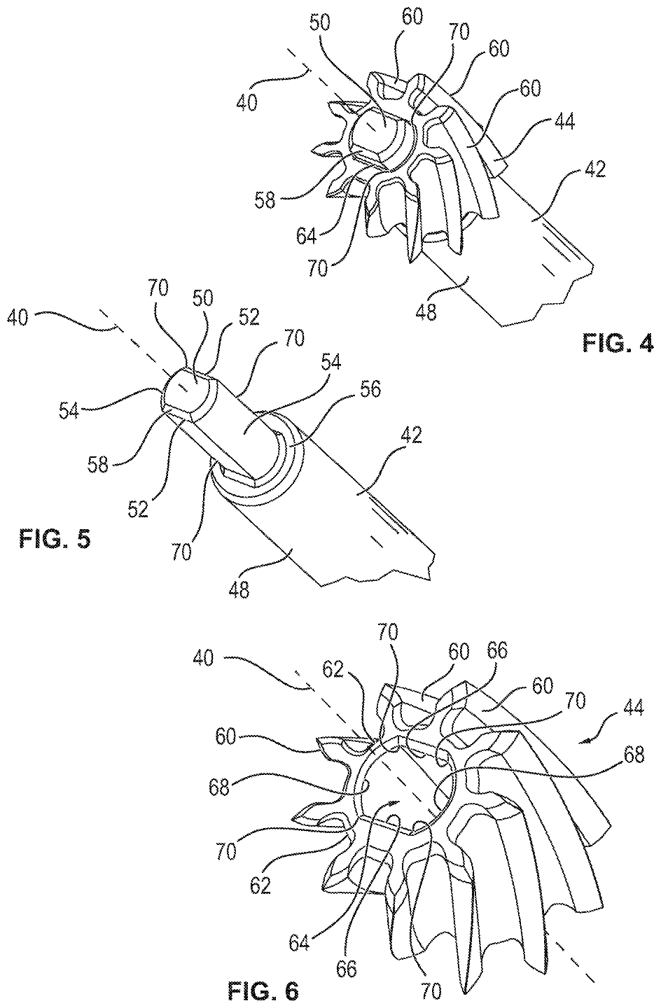

FIG. 4 shows a perspective fragmented view of the rotor shaft having a gear wheel placed thereon;

FIG. 5 shows the rotor shaft according to FIG. 4 without the gear wheel, and

FIG. 6 shows a perspective view of the gear wheel.

Functionally equivalent parts are provided with the same reference signs in all figures.

A motor vehicle 2 in the form of a passenger motor vehicle is illustrated in a schematically simplified manner in FIG. 1. The motor vehicle 2 has a plurality of wheels 4 by means of which contact with a road surface, not illustrated in more detail, takes place. Some of the wheels 4 are driven by means of a main drive, not shown. For deceleration, the motor vehicle 2 has a plurality of brakes 6 of which only one is illustrated. Each of the brakes 6 comprises a brake disk 8 which is co-rotationally connected to the respectively assigned wheel 4. A brake caliper 10 of the brake 6, which has a plurality of brake pistons not illustrated in more detail, is fixedly held on the bodywork.

The brake pistons are a constituent part of a brake fluid system 12 which has a compensation vessel 14 that is fluidically coupled to the brake pistons. Furthermore, an ancillary unit 16 in the form of an electromechanical brake booster is coupled to the compensation vessel 14. This brake booster is activated by means of a foot pedal 18, specifically a brake pedal. The brake fluid system 12 is filled with a brake fluid, and, when the foot pedal 18 is activated, a pressure in the brake fluid system 12 is increased by means of the electrical ancillary unit 16, thus the electromechanical brake booster, in such a way that the brake pistons are activated by way of the compensation vessel 14. Consequently, brake pads which are fastened to the brake caliper 10 are pressed against the assigned brake disk 8 in such a way that the motor vehicle 2 is decelerated.

In FIG. 2, the ancillary unit 16, thus the electromechanical brake booster, is illustrated in a sectional illustration along a longitudinal axis 19. This ancillary unit 16 has a pump chamber 20 within which is disposed a working piston 22, the latter being guided along the longitudinal axis 19 by means of the lateral wall of the pump chamber 20. The working piston 22 reaches up to the internal walls of the pump chamber 20 in such a way that the latter is divided into two parts by means of the working piston 22. One of the parts is fluidically connected to the compensation vessel 14 by way of an outlet, not illustrated in more detail, and is completely filled with the brake fluid. In this way, the quantity of the brake fluid disposed in the pump chamber 20 is varied when the working piston 22 moves in the pump chamber 20.

The working piston 22 is fastened to an input rod 26 by way of a connecting rod 24 which is disposed parallel to the longitudinal axis 19, said input rod 26 likewise extending along the longitudinal axis 19 and being mounted so as to be displaceable along the longitudinal axis 19 by means of a mounting, not illustrated in more detail. However, the input rod 26 herein is co-rotationally mounted in such a way that rotation of the input rod 26 is avoided. The input rod 26 is supported on the foot pedal 18 by means of a mechanism on the end lying opposite the connecting rod 24.

When the foot pedal 18 is activated, the input rod 26 and consequently also the connecting rod 24 are moved along the longitudinal axis 19 in such a way that the working piston 22 is also moved. Consequently, the brake fluid is forced out of the pump chamber 20. Furthermore, the ancillary unit 16 has a spring which is not illustrated in more detail and by means of which the input rod 26, and therefore also the connecting rod 24, and consequently also the working piston 22, are impinged. Due to the spring force, the working piston 22 is moved out of the pump chamber 22 as far as possible in such a way that a volume of brake fluid received by the pump chamber 20 is at the maximum.

The input rod 26 has an external toothing, and placed thereon is a drive pinion 28 which in turn has an internal toothing. The input rod 26 and the drive pinion 28 are thus designed in the manner of a spindle. Additionally, the drive pinion 28 has an external toothing and engages with a gearbox 30. The gearbox 30 is driven by means of an electric motor 32 which comprises a motor housing 34 within which is disposed a hollow-cylindrical stator 36. A likewise hollow-cylindrical rotor 38 is disposed concentrically with a rotor axis 40 within the stator 36 and is co-rotationally fastened to a rotor shaft 42 running concentrically with the rotor axis 40. Consequently, the rotor shaft 42 is disposed along the rotor axis 40. The rotor shaft 42 is mounted so as to be rotatable about the rotor axis 40 by means of bearings not illustrated in more detail.

The rotor 38 comprises a laminated core which is not illustrated in more detail and on which permanent magnets, likewise not illustrated in more detail, are held, said permanent magnets during operation interacting with solenoids of the stator 36, that are in each case formed by means of an electric coil, in such a way that the rotor 38 and therefore also the rotor shaft 42 are rotated about the rotor axis 40. Consequently, the electric motor 32 is designed as a brushless DC (BLDC) motor. A gear wheel 44 which engages with the gearbox 30 is co-rotationally fastened to the end side on the rotor shaft 42. In this way, a transmission of force from the rotor shaft 42 to the gearbox 30 takes place via the gear wheel 44 which meshes with a corresponding gear wheel of the gearbox 30.

The ancillary unit 16 furthermore comprises a sensor 46 by means of which an activation of the foot pedal 18, specifically an offset of the input rod 26 along the longitudinal axis 19, is detected. The electric motor 32 is energized as soon as this has been detected, so that the drive pinion 28 is rotated by way of the gearbox 30. By virtue of the interlocking action with the input rod 26, an additional force is applied to the input rod 26 along the longitudinal axis 19 in this way, so that the activation of the foot pedal 18 is assisted. Owing to the force exerted by means of the drive pinion 28 and the activation of the foot pedal 18, the working piston 22 is moved in the pump chamber 20, and a driver of the motor vehicle 2 is thus assisted during braking. In summary, the force to be applied for braking by the driver is reduced, which enhances the level of comfort. It is also possible for the ancillary unit 16, thus the electromotive brake booster, to be activated in a manner completely independent of the activation of the foot pedal 18. Consequently, braking of the motor vehicle 2 is performed independently of the activation of the foot pedal 18, for example in the context of emergency braking, or during an automatic/autonomous operation of the motor vehicle 2. Owing to the functional mode of the ancillary unit 16, a comparatively high level in terms of dynamics of the electric motor 32, and therefore a small inertia of the rotor 38 as well as of the rotor shaft 42 and of the gear wheel 44, are required.

The electric motor 32, which has the pot-shaped motor housing 34 within which the stator 36 is disposed, is illustrated in a perspective fragmented view in FIG. 3. The rotor 32 is not shown, but the rotor shaft 42 which extends along the rotor axis 40 and onto the end side of which the gear wheel 44 is placed.

Illustrated in a perspective view in FIG. 6 is the rotor shaft 42 which extends along the rotor axis 40 and shown with the gear wheel 44 placed thereon in a fragmented perspective view in FIG. 4, and shown with the gear wheel 44 removed in FIG. 5. The rotor shaft 42 is integrally produced from high-grade steel and has a cylindrical main portion 48 which has a round cross section perpendicular to the rotor axis 40. The rotor 38 is co-rotationally fastened to the cylindrical main portion 48, and the bearings, not illustrated in more detail, are also attached to the main portion 48.

An assembly portion 50 of the rotor shaft 42 adjoins the main portion 48, said assembly portion 50 representing one of the ends of the rotor shaft 42 along the rotor axis 40 which is disposed parallel to an axial direction. The assembly portion 50 has a barrel-shaped cross section perpendicular to the rotor axis 40, having two mutually parallel main edges 52 which are identically spaced apart from the rotor axis 40. Furthermore, the barrel-shaped cross section of the assembly portion 50 comprises two convex edges 54 which thus are curved or arcuate, whereby the center of the arc lies on the rotor axis 40. Consequently, the barrel-shaped cross section is designed in the manner of a dihedron.

The radius of the arc of the convex edges 54 is smaller than the radius of the round cross section of the main portion 48, so that a circumferentially encircling step 56 is formed between the assembly portion 50 and the main portion 48. A cylindrical bar, which has the same length as the rotor shaft 42, is utilized for producing the rotor shaft 42. The main portion 48 is formed directly by means of the corresponding part of the cylindrical bar, and material is subtracted, in particular milled, from said cylindrical bar in order to produce the assembly portion 50. Consequently, a time required for producing the rotor shaft 42 is comparatively short. Furthermore, that end of the assembly portion 50 that faces away from the main portion 48 is beveled, and thus has a bevel 58. With the exception of the bevel 58, the cross section of the assembly portion 50 is constant along the entire extent along the rotor axis 40.

The gear wheel 44 is produced by means of sintering and has a plurality of teeth 60, one trough 62 being in each case disposed therebetween in the tangential direction relative to the rotor axis 40. The teeth 60 have an involute toothing and a helical toothing. In other words, the teeth 60 do not run parallel to the rotor axis, and a helix shape is partially described by means of each tooth 60.

The gear wheel 44 has a central assembly opening 64 which extends along the rotor axis 40 and has a barrel-shaped cross section perpendicular to the rotor axis 40. In this way, the assembly opening 64 likewise has two mutually parallel main edges 66 and two convex edges 68. In the assembled state, the assembly portion 50 is disposed within the assembly opening 64 in such a way that the gear wheel 44 is placed onto the assembly portion 50. In other words, the assembly portion 50 is circumferentially surrounded by means of the assembly opening 64, and consequently by means of the gear wheel 44. That end of the gear wheel 44 herein that faces the main portion 48 rests on the step 56 in such a way that the gear wheel 44 is partially stabilized therewith. The position of the gear wheel 44 along the rotor axis 40 on the rotor shaft 42 is also determined by means of the step 56.

An interference fit is established between the main edges of the assembly portion 50 and the main edges 66 of the assembly opening 64, thus the respective cross sections thereof, in such a way that the flat areas of the assembly opening 64 and of the assembly portion 50 rest on one another in a force-fitting manner. A clearance fit is established between the convex edges 54 of the assembly portion 50 and the convex edges 68 of the assembly opening 64 in such a way that said edges only rest loosely on one another. Consequently, the gear wheel 44 is only under tensile stress in the regions of the convex edges 68, so that overloading of the gear wheel 44 is avoided in the region of the convex edges 68, in which a wall thickness of the gear wheel 44 is reduced.

Centering of the gear wheel 44 on the rotor shaft 42 is performed by means of the convex edges 54, 68 in such a way that said gear wheel 44 is suitably aligned. Placing the gear wheel 44 onto the assembly portion 50 is facilitated by virtue of the bevel 58, so that a comparatively strong force-fit of the interference fit between the main edges 52, 66 is made possible while keeping assembling comparatively simple.

During operation, a transmission of force takes place between the gear wheel 44 and the rotor shaft 42 by way of the areas defined by means of the main edges 52, 66, whereby the convex edges 54, 68 are not stressed. Moreover, friction is increased by virtue of the interference fit between the main edges 52, 66. Therefore, it is precluded that the gear wheel 44 is released from the rotor shaft 42, despite the helical toothing of the gear wheel 44 and the force acting parallel to the rotor axis 40 during operation, said force being caused by the helical toothing.

One corner 70 is in each case formed between the main edges 66 and the respectively neighboring convex edges 68 of the cross section of the assembly opening 64, and thus, by virtue of the interference fit, or the clearance fit, respectively, between the gear wheel 44 and the assembly portion 44, also between each main edge 52 and the convex edges 54 of the cross section of the assembly portion 50. One of the corners 70 of the assembly portion 50 herein rests in each case on one of the corners 70 of the assembly opening 64. One of the teeth 60 of the gear wheel 44 is in each case disposed in a radial direction, which is determined by the rotor axis 40, relative to the corners 70 in such a way that a wall thickness of the gear wheel 44 is increased by virtue of the respective tooth 60 in the region of each of the corners 70. In summary, one of the teeth 60 of the gear wheel 44 is in each case disposed so as to neighbor each of the corners 70 in the radial direction.

Continuous coverage of the corners 70 by means of each of the teeth 60 is impossible here by virtue of the helical toothing. However, the region along the rotor axis 40, in which one of the troughs 62 adjoins the respective corners 70 in the radial direction, is reduced to the minimum.

Consequently, in the cross section perpendicular to the rotor axis 40 of the assembled unit on the assembly portion 50 and the gear wheel 44, one of the teeth 60 of the gear wheel 44 is in each case disposed so as to largely neighbor the corners 70 in the radial direction. It is consequently made possible to further reduce a spacing of the troughs 62 from the rotor axis 40, and thus also a weight of the gear wheel 44, whereby the gear wheel 44 is not compromised in terms of robustness, not even in the region of the corners 70.

The invention is not limited to the exemplary embodiment described above. Instead, other variants of the invention may also be derived therefrom by a person skilled in the art without departing from the subject matter of the invention. All of the individual features described in connection with the exemplary embodiments are furthermore in particular also able to be combined with one another in other ways without departing from the subject matter of the invention.

### LIST OF REFERENCE SIGNS

2 Motor vehicle
4 Wheel
6 Brake
8 Brake disk
10 Brake caliper
12 Brake fluid system
14 Compensation vessel
16 Ancillary unit
18 Foot pedal
19 Longitudinal axis
20 Pump chamber
22 Working piston
24 Connecting rod
26 Input rod
28 Drive pinion
30 Gearbox
32 Electric motor
34 Motor housing
36 Stator
38 Rotor
40 Rotor axis
42 Rotor shaft
44 Gear wheel
46 Sensor
48 Main portion
50 Assembly portion
52 Main edge
54 Convex edge
56 Step
58 Bevel
60 Tooth
62 Trough
64 Assembly opening
66 Main edge
68 Convex edge

1-8. (canceled)

9. An electric motor of an ancillary unit or electromechanical brake booster of a motor vehicle, the electric motor comprising:
a rotor shaft disposed along a rotor axis, said rotor shaft including:
a cylindrical main portion having a round cross section perpendicular to said rotor axis, and
an assembly portion adjoining said main portion and having a barrel-shaped cross section perpendicular to said rotor axis, two mutually parallel main edges, and two convex edges; and
a gear wheel disposed on said assembly portion, said gear wheel having a central assembly opening with a barrel-shaped cross section perpendicular to said rotor axis.

10. The electric motor according to claim 9, wherein said gear wheel is helically toothed relative to said rotor axis.

11. The electric motor according to claim 9, wherein said assembly opening has main edges, and an interference fit is established between said main edges of said assembly portion and said main edges of said assembly opening.

12. The electric motor according to claim 9, wherein said assembly opening has convex edges, and a clearance fit is established between said convex edges of said assembly portion and said convex edges of said assembly opening.

13. The electric motor according to claim 9, wherein said assembly opening has main edges, convex edges and corners each formed between a respective one of said main edges and a respective adjacent one of said convex edges, said gear wheel has teeth, and each tooth is disposed adjacent to a respective one of said corners in a radial direction.

14. The electric motor according to claim 9, wherein said rotor shaft has a circumferentially encircling step formed between said assembly portion and said main portion.

15. The electric motor according to claim 9, wherein said assembly portion has a beveled end facing away from said main portion.

16. An ancillary unit or electromechanical brake booster of a motor vehicle, the ancillary unit or electromechanical brake booster comprising an electric motor according to claim 9.
